(19) United States
(12) Patent Application Publication
(10) Pub. No.: US 2018/0020860 A1
(43) Pub. Date: Jan. 25, 2018

(54) Arrangement for Dispensing Curtains

(71) Applicant: Annie Laura Thomas, Chicago, IL (US)

(72) Inventor: Annie Laura Thomas, Chicago, IL (US)

(21) Appl. No.: 15/658,347

(22) Filed: Jul. 24, 2017

Related U.S. Application Data
(60) Provisional application No. 62/494,041, filed on Jul. 25, 2016.

(51) Int. Cl. A47H 1/08; A47H 15/04; E06B 9/42

(52) U.S. Cl. CPC A47H 1/08; E06B 9/42; A47H 15/04

(57) ABSTRACT

The arrangement for dispensing a curtain using an extendable tube with mating rods and cartridges provides an expedient and convenient method for mounting, changing and removing curtains. It consists primarily of an extendable tube housing a cartridge for dispensing a curtain that is pre-assembled with attached circular balls and a guide piece. The cartridge is attached to mating rods that can be adjusted as needed to attach or remove additional cartridges. The user pulls the guide piece in a downward direction to release the curtain from the release chamber of the extendable tube. The circular balls spread along the sliding tracks of the extendable tube and the user can then spread the curtain as desired

### BACKGROUND OF THE INVENTION

This application claims priority of U.S. Provisional Application Ser. No. 62/494,041 filed Jul. 25, 2016, the entire contents of which is incorporated herein by reference thereto.

The present invention relates to an arrangement for dispensing curtains. More particularly, the present invention pertains to a curtain dispenser that enables a user to easily hang a curtain, remove a used curtain and readily dispense a new curtain from the cavity of an extendable tube.

The conventional curtain arrangements that are present in the marketplace do not provide a function where a pre-wrapped curtain with hanging elements is drawn in a downward position from the release cavity of a circular tube and with spreading means to cover a space where privacy is desired. This unique functioning of the present invention is useful for providing a quick and expedient method for mounting a curtain and subsequently dispensing a new curtain as desired. Multiple curtains can be stored individually within the extendable tube, thereby saving time and simplifying the task of changing a curtain. This invention provides for sufficient coverage in any space by easily adjusting the extendable tube.

It is a well-known custom to rinse out or wash curtains after extended use and waiting for the curtain to dry before rehanging. The inventive concept of the present invention provides for a quick removal of a used curtain and an instant replacement of a fresh and unused curtain.

The installation of curtains between adjacent walls or atypical spaces is traditionally not a simple procedure and is often time consuming. Mounting with tension rods or mounted rods often requires changing established instructions to suit the specific needs of the user. Achieving proper suspension from these rods being mounted to ceilings, window frames or the like can produce additional frustration. A user might often require additional measuring in order to ensure that the curtain is properly placed and hangs as desired. These elements combined provide for a laborious and unsafe hanging process.

The present invention helps to overcome the problems associated with hanging and replacing a curtain by providing an arrangement for dispensing curtains that is convenient to use and mainly addressing the problems of hooking and unhooking a curtain.

This new arrangement eliminates the need for hanging, hooking or laying out the curtain by providing a curtain that is held in a wrapped and pre-assembled configuration within an extendable tube. The curtain is ready to use within seconds by releasing the curtain inside a sliding rail arrangement and spreading the curtain with pre-attached circular balls. This arrangement allows a user to conveniently mount a curtain without additional steps, hooks or tooling. The extendable tube and mating rods aid the installer in positioning the arrangement to the pre-mounted end caps that are adapted to mount as suction cups on a wall surface. This feature in combination with the extendable arrangement and releasable curtains makes the invention easy to install and use.

Rehanging of a previously discharged and washed curtain is an equally expedient process. The arrangement is removed from the mounted position and a pre-filled cartridge is inserted into the extendable tube by a sliding engagement with the mating rod. The entire arrangement can be removed from the wall and transported away by compressing the extendable tube longitudinally away from the end caps.

Long-term exposure to water, dust and other elements are obvious problems for curtains hung in showers, damp areas, or places that utilize a curtain for a long-term privacy solution. These are ideal conditions for breeding germs and causes fabric deterioration, shrinkage, discoloration, molds, spotting and foul odors. This new arrangement for dispensing curtains features ventilation openings being embedded on top of the extendable tube. The ventilation openings facilitate the rapid drying of the fabric and odors are released.

This invention is especially helpful for people who suffer from chronic pain or have limited dexterity. These individuals would prefer an easy method of replacing a curtain arrangement. The mating rods are quickly removed to roll the used curtain out of the sliding rail. A new tab can be quickly released to expose and spread a new curtain.

The arrangement is low-cost, easy to manufacture, easy to assemble and provide for a quick and expedient manner for changing a curtain.

### BRIEF SUMMARY OF THE INVENTION

In view of the foregoing disadvantages associated with hanging curtains, an improved arrangement for dispensing curtains is presented. As such, the general purpose of the present invention is to provide a new and improved arrangement for dispensing curtains with an extendable tube that extends between opposing walls. The extendable tube being a housing device for mating rods with proximal ends that extend inside an extendable tube, holds a plurality of cartridges and dispenses pre-assembled curtains.

Another objective of the present invention is to provide an arrangement for dispensing a curtain that is easy to install. The extendable tube and at least one pre-filled cartridge with a mating rod thereon is suctioned or releasably connected to adjacent walls. Guide tabs are used to dispense the curtain that is housed in a wrapped configuration on the cartridge. Circular balls spread along the sliding tracks of the extendable tube as the curtain is released. The user can then spread the curtain as desired.

Another object of the present invention is to provide an arrangement for dispensing curtains that makes it easy and convenient to mount a curtain. The mating rods are removed and a new cartridge is placed in the release cavity of the extendable tube. The user then uses the guide piece to release the curtain and to extend the curtain across the sliding track.

Still another objective of the present invention is to provide a curtain dispenser that has ventilation openings serving as exit points for humidity and heat within the extendable tube. They provide for the removal of heat, water and humidity from the inside of the extendable tube. This allows the curtains to dry after use or to remove any accidental spillage of water into the device.

Still another objective of the present invention is to provide a curtain dispenser that is easy to adjust and reuse in a different setting or surface arrangement. The arrangement can be shortened or lengthened by sliding the extendable tube in cooperation with the mating rods longitudinally towards or away from the outer walls of the extendable tube and the proximal ends.

Still another objective of the present invention is to provide a curtain dispenser that dispenses a plurality of pre-assembled curtains that are housed in a wrapped configuration in individual cartridges. The themed curtain can be selected as needed by the user.

Henceforth, a new and improved arrangement for dispensing curtains with an extendable tube, mating rods and cartridges is presented. This invention utilizes and combines known technologies in a new configuration in order to overcome a long felt need in the art.

Additional advantages of the invention will become apparent from the following detailed description taken in conjunction with the accompanying drawings.

### BRIEF DESCRIPTION OF THE SEVERAL VIEWS OF THE DRAWINGS

FIG. 1 is an exemplary representation of the materials needed to practice the invention as claimed herein.

FIG. 2 is a cutaway view of the extendable tube.

FIG. 3 is a perspective view of a plurality of cartridges.

FIG. 4 is a perspective view of an extendable tube with a guide piece being exposed.

FIG. 5 is a perspective view of an extendable tube with a wrapped curtain being extended.

FIG. 6 is a perspective view of an extendable tube with a curtain being extended along a sliding track.

### DETAILED DESCRIPTION OF THE INVENTION

The present invention derives from the long-standing recognition that the tradition of installing and removing curtains is a time-consuming and laborious process. The present invention provides advantageous features for an arrangement of dispensing curtains and provides relief for users who desire a quick and easy installation or removal of a curtain. The arrangement employs an adjustable device that is easy to install and is adjusted based on the user's need to dispense, remove or rehang a curtain.

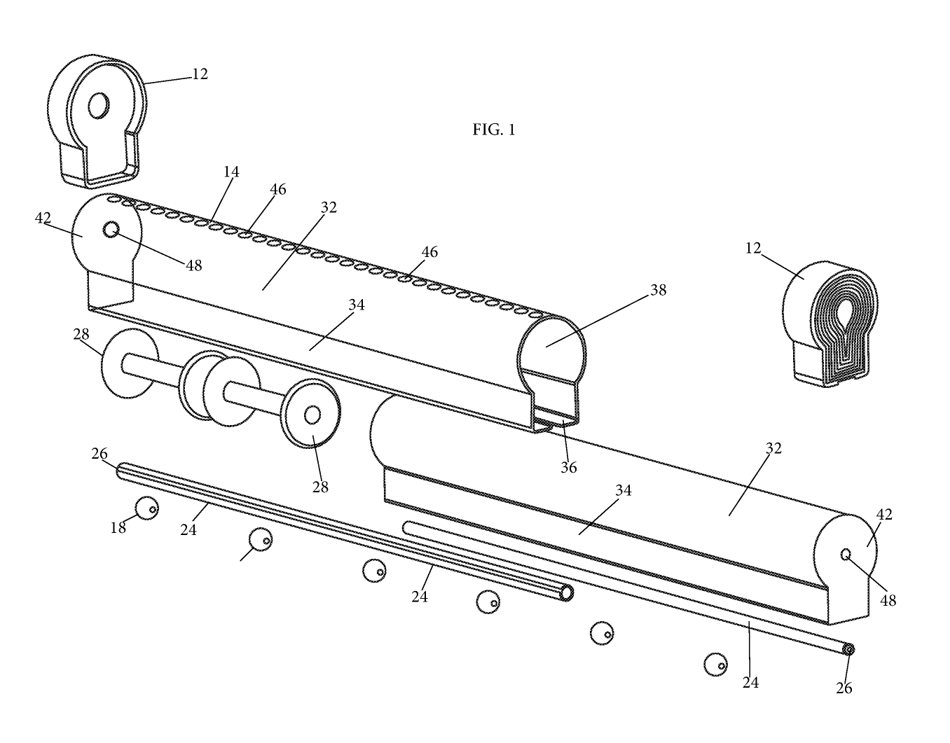

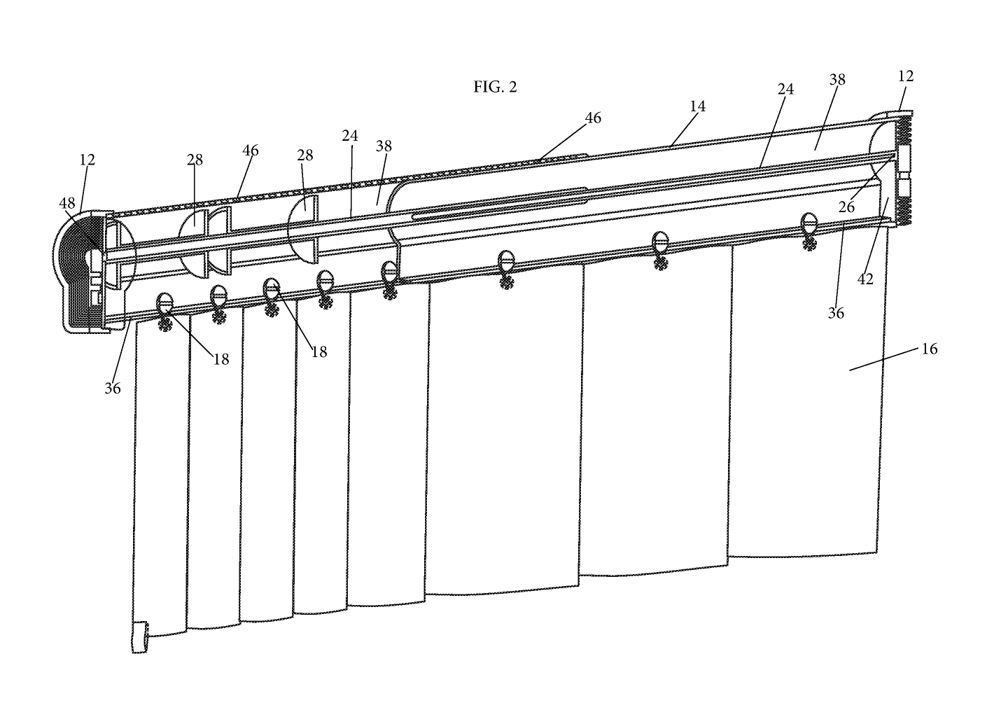

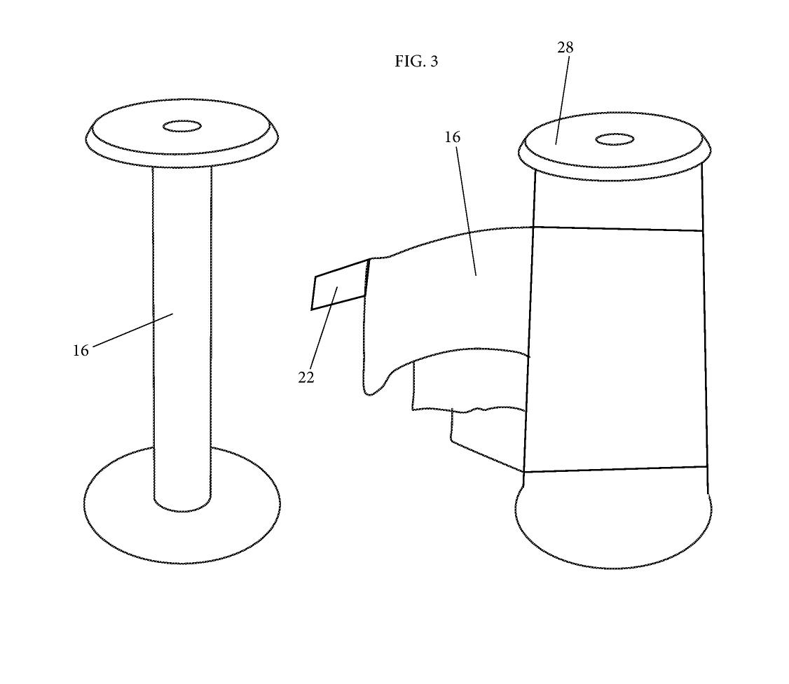

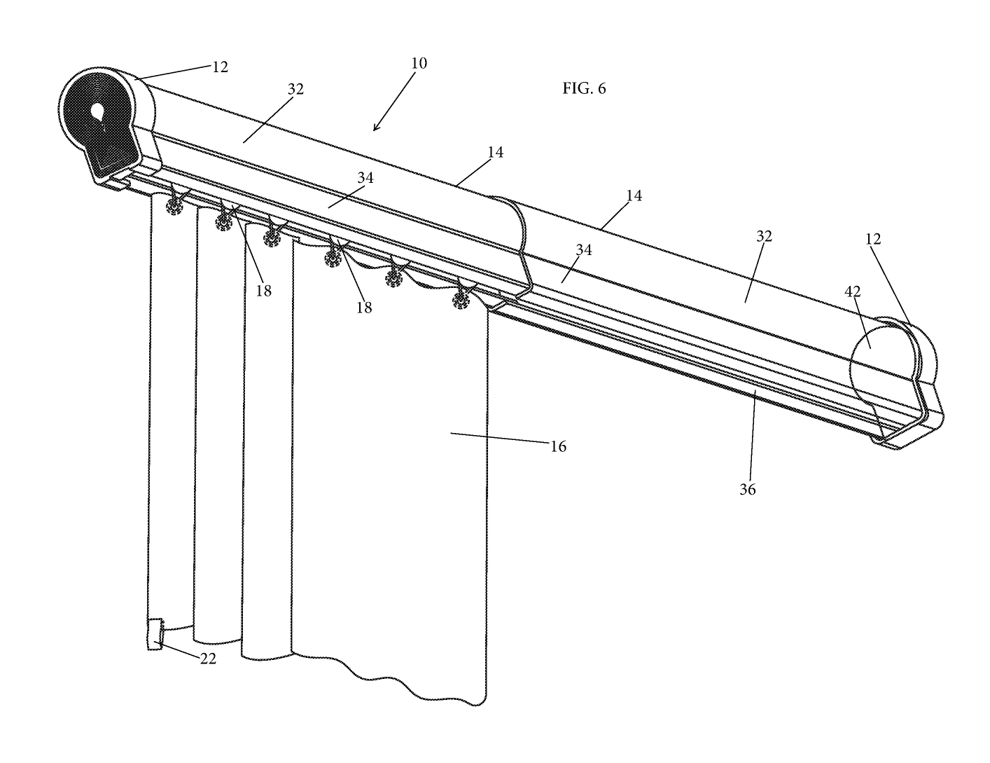

Turning now to FIGS. 1-6 of the attached drawings, the invention employs an arrangement 10 for dispensing a curtain 16 between adjacent surfaces with end caps 12 being mounted on each end of the arrangement 10. An extendable tube 14 is used for dispensing a curtain 16 with attached circular balls 18 and a guide piece 22 that extend between opposing surfaces. The extendable tube 14 is a housing device for mating rods 24 with proximal ends 26 that extend inside the extendable tube 14 and a plurality of cartridges 28 for dispensing the curtain 16 that is housed in a wrapped configuration in the cartridge 28.

The extendable tube 14 has a top section 32, a bottom section 34, a sliding track 36, a release cavity 38, outer walls 42, end caps 12 and ventilation openings 46. The top section 32 of the extendable tube 14 has a generally circular interior. The end caps 12 are releasably connected to the outer walls 42 of the extendable tube 14 and the sliding track 36 is attached to the bottom section 34 of the extendable tube. The sliding track 36 has a generally rectangular configuration and is aligned in a parallel configuration to the top section 32 of the extendable tube 14. The release cavity 38 provides for the quick release of the circular balls 18 into the sliding track 36 and the spreading of the curtain 16 through the sliding track 36. The outer walls 42 of the extendable tube have circular openings 48 for receiving the mating rods 24. The outer walls 42 function as receiving elements for the mating rods 24. The mating rods 24 can be connected to said circular openings by screwing, force fitting, extension towards said end caps 12, and by utilizing additional methods of connecting a rod to a vertical plane.

The ventilation openings 46 are exit points for humidity and heat within the extendable tube 14. They provide for the removal of heat, water and humidity from the inside of the extendable tube 14 and allow the curtains to dry after use. The ventilation openings 46 provide positive pressure ventilation when used in tandem with the existing openings along the sliding track 36.

The mating rods 24 extend through said cartridges 28 and allow for their independent rotation. The mating rods 24 are in parallel configuration with the extendable tube 14. The cartridges 28 are loosely held within the extendable tube 14 and are held in parallel configuration with the extendable tube 14 and the mating rods 24. The mating rods 24 and the cartridges 28 do not collide with the release cavity 38 or other areas of the extendable tube 24. The cartridges 28 conform to the general shape of the release cavity 38 and prevent entanglement or of the curtain 16 during storage and while extracting the curtain 16 therefrom.

The curtain 16 has circular balls 18 and a guide piece 22 that is attached thereon. For dispensing purposes, the guide piece 22 can be tongues, ropes, pins, ties, studs or any similar guide to aid in the removal of the curtain 16. The curtain 16 is sufficiently sized to easily pull away from the cartridge 28 when the guide piece 22 is pulled. The curtain 16 is released by slightly pulling the guide piece 22 until the curtain 16 travels downwardly through the sliding track 36. The sliding track 36 catches and supports the circular balls 18 once the curtain 16 is released and thereby causing the circular balls 18 to spread within the sliding track 36.

The arrangement 10 can be shortened or lengthened by sliding the extendable tube 14 and the mating rods 24 longitudinally towards or away from the outer walls 42 of the extendable tube 14.

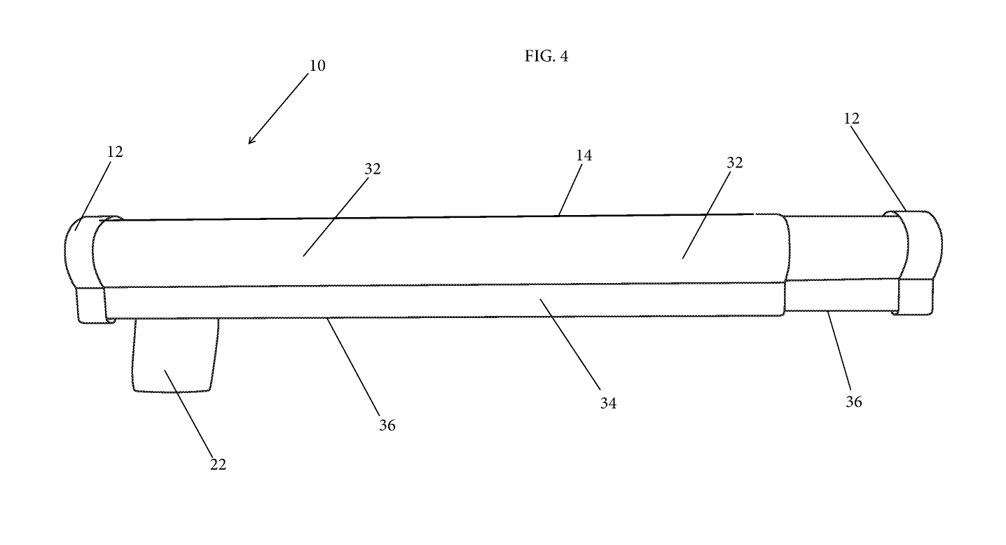

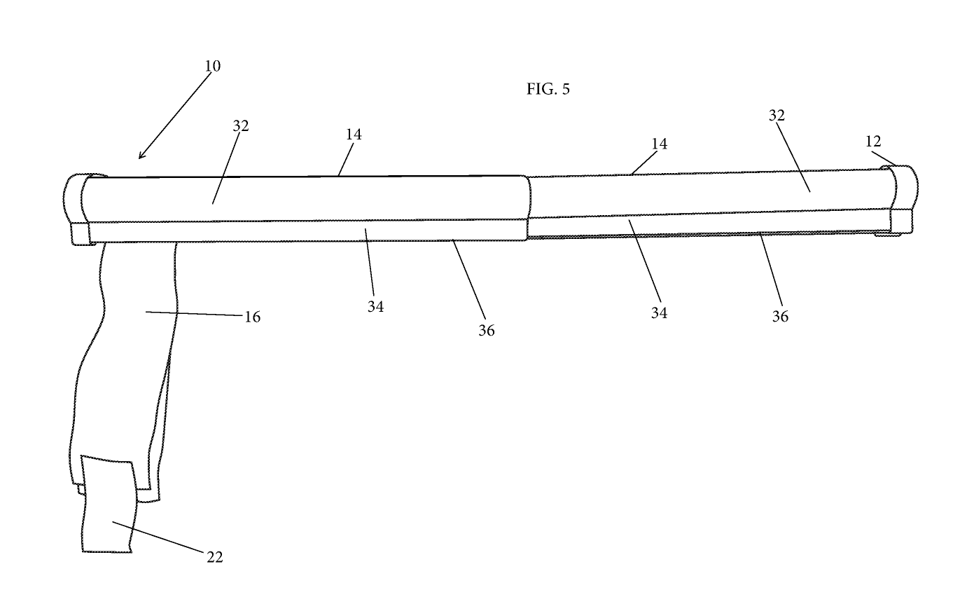

As shown in FIGS. 4 and 5, the curtain 16 is dispensed as the guide piece 22 is drawn downwardly. The guide piece 22 is then used to extend the curtain 16 across the sliding track 36. The cartridge 28 rolls around the mating rods 24 and is prevented from dropping into the release cavity 38 as the curtain 16 is drawn downwardly and moved across the sliding track 36.

The arrangement 10 can hold a plurality of cartridges 28 and is adapted to dispense a plurality of themed curtains 16 that can be selected as needed based on the celebratory needs of the user. The themes can include Halloween, religious celebrations, Thanksgiving, birthdays, university emblems, patriotic symbols and various other types of celebratory or decorative themes.

Manufacturing of the arrangement 10 and in particular both the extendable tube 14 and the mating rods 24 can be simplified by making these elements the same length. The cartridge 28 can be constructed in various sizes and utilize additional retaining elements to facilitate a quick release of the curtains 16 and prevent entanglement of the curtain 16 when not in use. The extendable tube 14, mating rods 24 and circular balls 18 of the present invention may be constructed from stainless steel, molded plastic, iron, plated brass, or any other rigid material. Thermoplastic synthetic materials would also provide a smoother surface to allow the frictionless movement of the cartridges 28, circular balls 18, and mating rods 24. The material used to produce the curtain will depend on the use of the arrangement. For example, wrinkle free fabrics can be used to dispense curtains in a formal setting while a plastic material could be used in a shower.

Various types of fabrics can be used to manufacture the curtains 16. These include netting fabrics, silk, wool, flax, hemp, cotton, plastic, woven and non-woven fabrics, knitted fabrics, technical fabrics (such as Gore-Tex® and Gannex®) and fabrics consisting of natural or artificial fibers. This invention can be used as curtains 16 in an open room arrangement, window box coverings, showers, dormitories, hotels, hospitals, and nursing homes, airplanes or as a hanging arrangement in any location where privacy is desired.

Although a specific embodiment of the invention has been shown to illustrate the principles of the invention, it should be clear that many modifications can be made that do not depart from these principles and therefore this invention should be limited only by the spirit and scope of the following claims.

What is claimed is:

1. an arrangement for dispensing a curtain between adjacent surfaces with end caps being mounted on each end of said arrangement, said arrangement comprising:
a. an extendable tube for dispensing said curtain with attached circular balls and a guide piece, said extendable tube being a housing device for mating rods with proximal ends that extend inside said extendable tube and a plurality of cartridges for dispensing said curtain that is housed in a wrapped configuration on said cartridge,
b. said extendable tube having a top section, a bottom section, a sliding track, a release cavity, outer walls, said end caps and ventilation openings; said top section of said extendable tube having a generally circular contour; said end caps being releasably connected to said outer walls of said extendable tube; said sliding track being attached to said bottom section of said extendable tube, said sliding track having a generally rectangular configuration and being aligned in a parallel configuration to said top section of said extendable tube; said release cavity providing for the quick release of said circular balls into said sliding track and spreading of said curtain through said sliding track; said outer walls having circular openings for receiving said mating rods, said outer walls receiving said mating rods in said outer wall, said ventilation openings being exit points for humidity and heat within said extendable tube,
c. said mating rods extending through said cartridges and allowing independent rotation of said cartridges, said mating rods being in parallel configuration with said extendable tube,
d. said cartridges being loosely held within said extendable tube and being held in parallel configuration with said extendable tube and said mating rods,
e. said curtain having said circular balls and said guide piece being attached thereon, said curtain pulling away from said cartridge when said guide piece is pulled, said curtain being released by slightly pulling said guide piece until said curtain travels downwardly through said sliding track, said sliding track catching and supporting said circular balls once said curtain is released and causing said circular balls to spread within said sliding track, said circular balls remaining within said sliding track.

2. The arrangement for dispensing a curtain of claim 1 wherein said arrangement is shortened by sliding said extendable tube and said mating rods longitudinally away from said outer walls of said extendable tube.

3. The arrangement for dispensing a curtain of claim 1 wherein said arrangement is extended by sliding said extendable tube and said mating rods longitudinally towards said outer walls of said extendable tube.

4. The arrangement for dispensing a curtain of claim 1 wherein said extendable tube houses a plurality of said curtain that is housed in a wrapped configuration on said cartridge.

5. The arrangement for dispensing a curtain of claim 1 wherein said arrangement dispenses a plurality of themed curtains that are selected as needed based on the celebratory needs of the user.

6. The arrangement for dispensing a curtain of claim 1 wherein said circular balls are manufactured in various sizes and shapes.
